(19) United States
(12) Patent Application Publication
(10) Pub. No.: US 2008/0206630 A1
(43) Pub. Date: Aug. 28, 2008

(54) Structural assembly of electric exchanger device

(75) Inventor: I-Chang Chang, Sijhih City (TW)

Correspondence Address: Troxell Law Office Pllc, Suite 1404, 5205 Leesburg Pike, Falls Church, VA, 22041, US

(73) Assignee: Jye Chuang Electronic Co., Ltd.

(21) Appl. No.: 11/709,882

(22) Filed: Feb. 23, 2007

(51) Int. Cl. H01M 2/24

(52) U.S. Cl. 429/121; 439/733.1

(57) ABSTRACT

The present invention provides a structural assembly of electric exchanger device, structured from a main body, a movable member and a restraining member. The main body is provided with a holding space that is able to accommodate connecting pin sets having different spacings and electrically connected to a detector circuit, thereby enabling the detector circuit to effectively detect polarity of a battery. The movable member and the restraining member further extend from the main body, and the movable member is able to rotate on the main body using press buttons, thereby facilitating accommodating batteries having pins at different positions. Furthermore, the restraining member enables securing a battery disposed within the holding space. Accordingly, the electric exchanger device is able to accommodate electrical connection to a variety of batteries having different pin positions, different spacings of pins or different numbers of pins.

### BACKGROUND OF THE INVENTION

(a) Field of the Invention

The art of the present invention provides a structural assembly of electric exchanger device, and more particularly to an electric exchanger device that uses a detector circuit electrically connected to connecting pin sets, and connecting pins of the connecting pin sets can be made to correspond to pin positions of different batteries.

(b) Description of the Prior Art

Referring to FIG. 1, which shows an electric exchanger of prior art, wherein disposition of electric contact pins A1 of an electric exchanger A is fixed, and positive pole contact pins and negative pole contact pins extending from a circuit configured within the electric exchanger A are fixed contact pins. If a user inserts a battery into the electric exchanger A having positive and negative pole contact pins of dissimilar disposition to those of the battery, then the electric exchanger A is unable to carry out charging of the battery, and may even cause damage to the battery.

Furthermore, the different sizes of a battery A2 and dissimilarity between position and spacings of electric contact pins of the battery A2 and the electric contact pins A1 results in the single electric exchanger A being configured to only accommodate specifications of the single specific battery A2. Hence, the electric exchanger A is unable to achieve accommodating charging of a large variety of batteries.

### SUMMARY OF THE INVENTION

The art of the present invention provides a structural assembly of electric exchanger device, and more particularly to an electric exchanger device that uses a detector circuit electrically connected to connecting pin sets, and connecting pins of the connecting pin sets can be made to correspond to pin positions of different batteries, thereby enabling the electric exchanger device to accommodate different batteries, and thus increasing multivariability and convenience of use.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view of prior art.

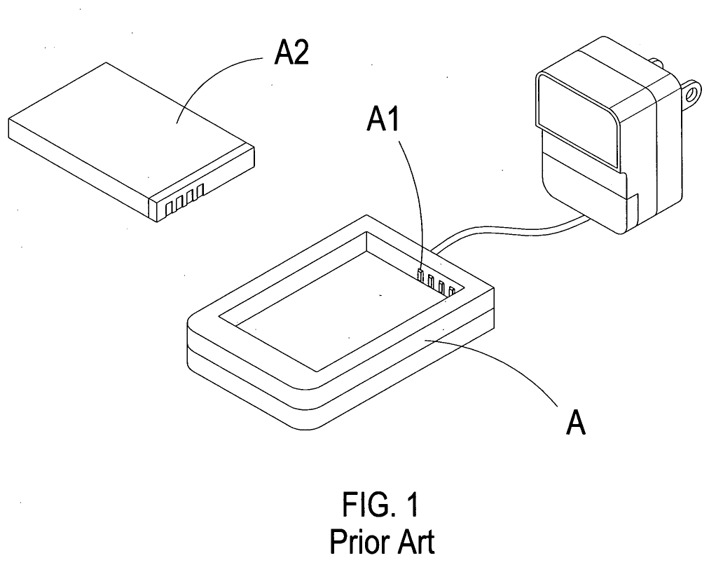

FIG. 2 shows an elevational view according to the present invention.

FIG. 3 shows an exploded elevational view according to the present invention.

FIG. 4 shows an enlarged partial schematic view of the present invention.

FIG. 5 shows a first elevational view of an embodiment according to the present invention.

FIG. 6 shows a second elevational view of the embodiment according to the present invention.

FIG. 7 shows a third elevational view of the embodiment according to the present invention.

FIG. 8 shows a first elevational view of an embodiment according to the present invention.

FIG. 9 shows a second elevational view of the embodiment according to the present invention.

FIG. 10 shows a first elevational view of an embodiment according to the present invention.

FIG. 11 shows a second elevational view of the embodiment according to the present invention.

FIG. 12 shows a first elevational view of an embodiment according to the present invention.

FIG. 13 shows a second elevational view of the embodiment according to the present invention.

### DETAILED DESCRIPTION OF THE PREFERRED EMBODIMENTS

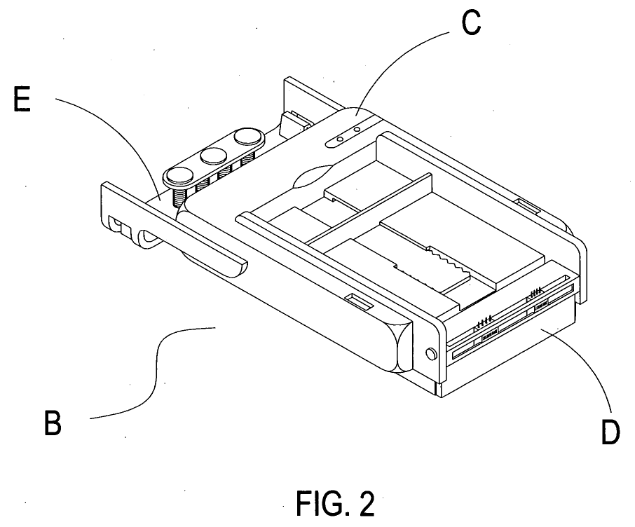

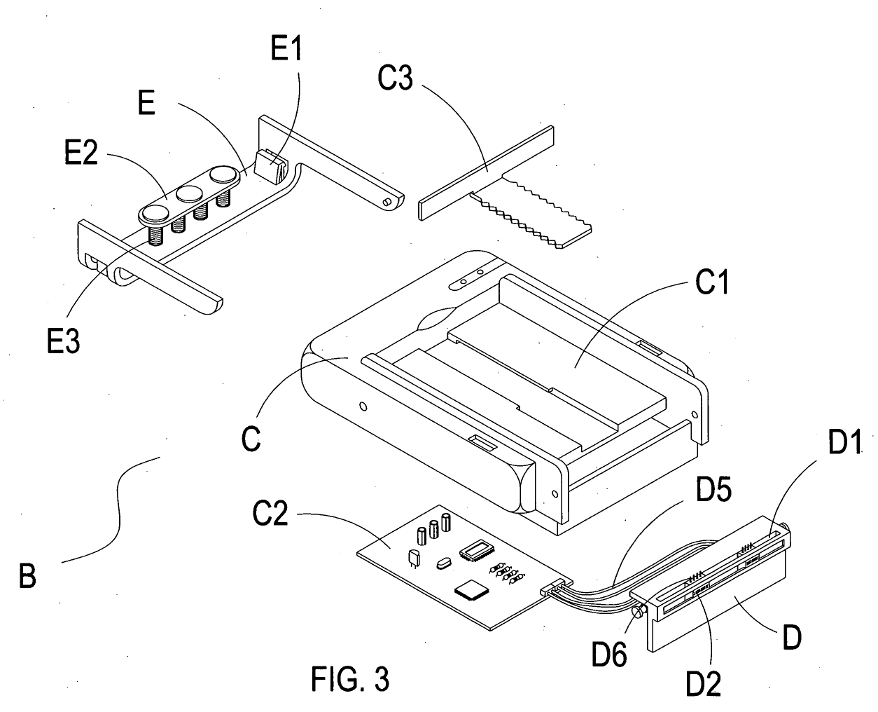

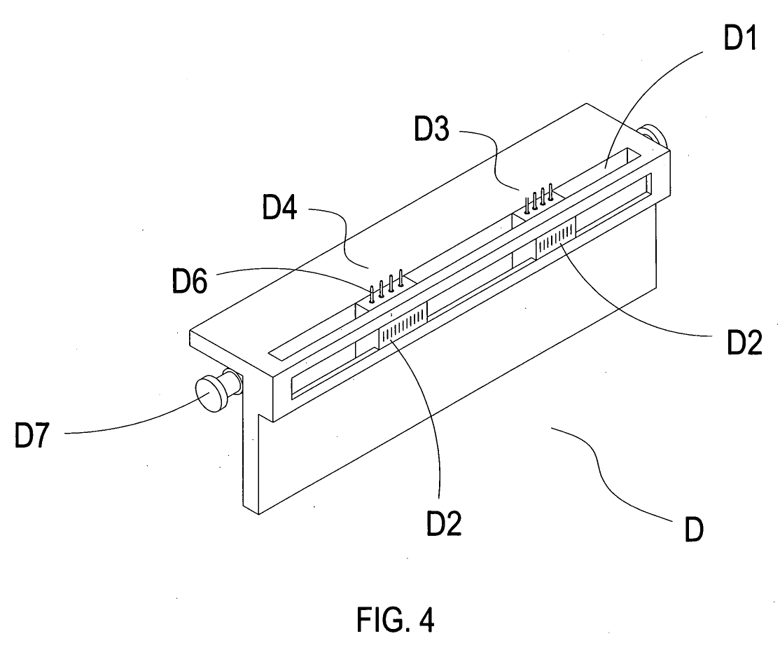

Referring to FIG. 2, FIG. 3 and FIG. 4, which show a structural assembly of electric exchanger device of the present invention, wherein an electric exchanger device B is structured to comprise a main body C, a movable member D and a restraining member E. The main body C is provided with a holding space C1 able to implement electrical connection, and the main body C is further configured with a detector circuit C2 that enables automatic detection of polarity. The detector circuit C2 is electrically connected to a plurality of connecting pin sets D3, D4 of the movable member D using conducting wires D5, and the plurality of connecting pin sets D3, D4 are configured with one or more than one connecting pin D6. Spacings between the connecting pins D6 of the connecting pin sets D3, D4 are different, and the connecting pins D6 face the holding space C1 of the main body C. A moving piece D2 extends from each of the connecting pin sets D3, D4, and the moving pieces D2 are able to move within a slide groove D1 of the movable member D, thereby increasing multivariability of electrical connection. Moreover, press buttons D7 are respectively located on two ends of the movable member D to enable effective rotating of the movable member D and fixing thereof. The main body C is further configured with a stopping strip C3 along with the restraining member E, wherein the stopping strip C3 can be moved in the holding space C1 to achieve clamping effectiveness, and the restraining member E is able to be movable disposed atop the main body C. Clasp pieces E1 correspondingly extend from the restraining member E, thereby enabling the restraining member E to be fixedly clasped onto the main body C using the clasp pieces E1. Moreover, a fixing piece E2 further extends from the restraining member E to face the holding space C1, and flexible members E3 are located between the fixing piece E2 and the restraining member E to enable contractibility of the fixing piece E2.

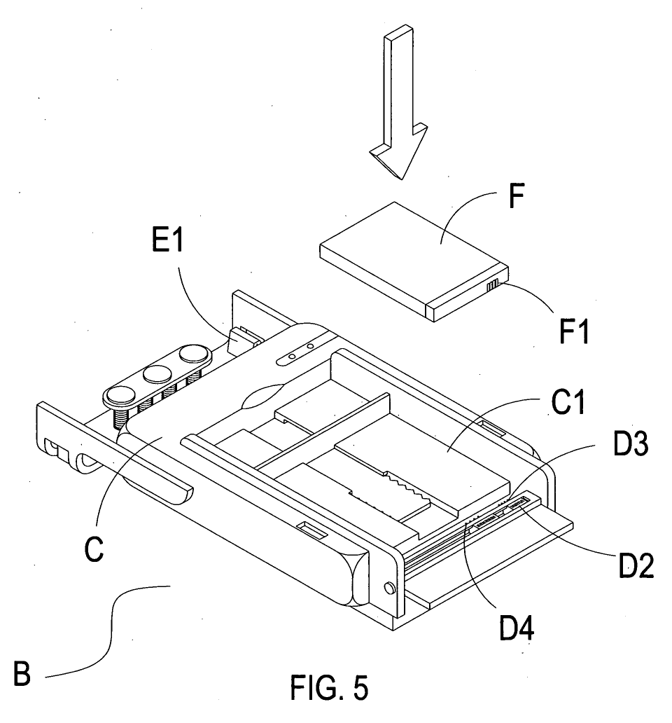

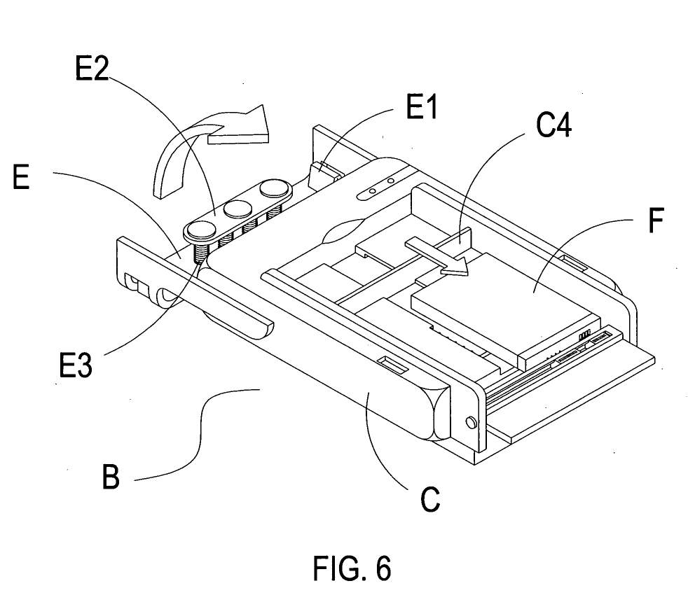

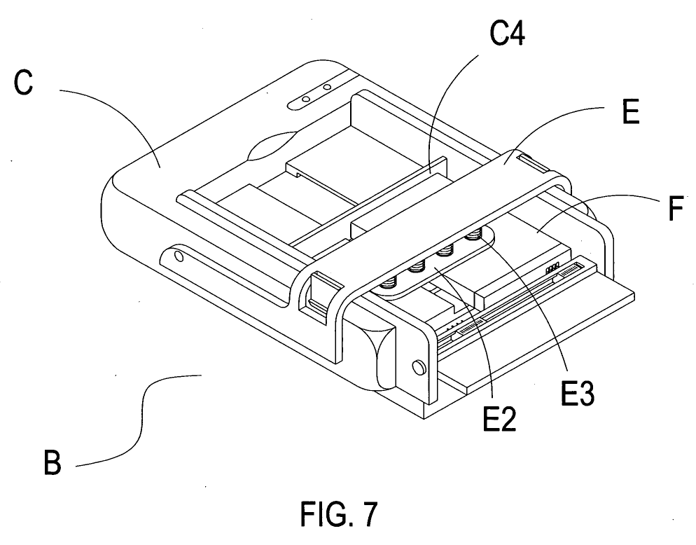

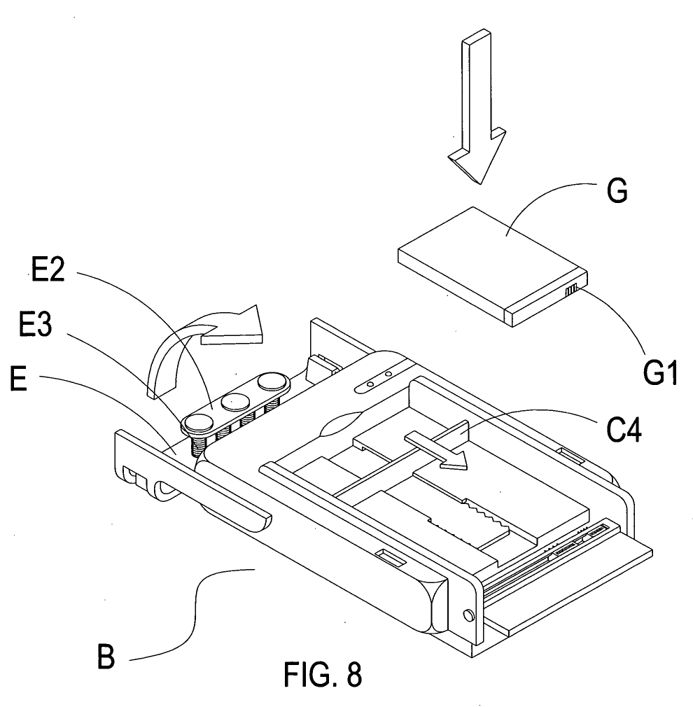

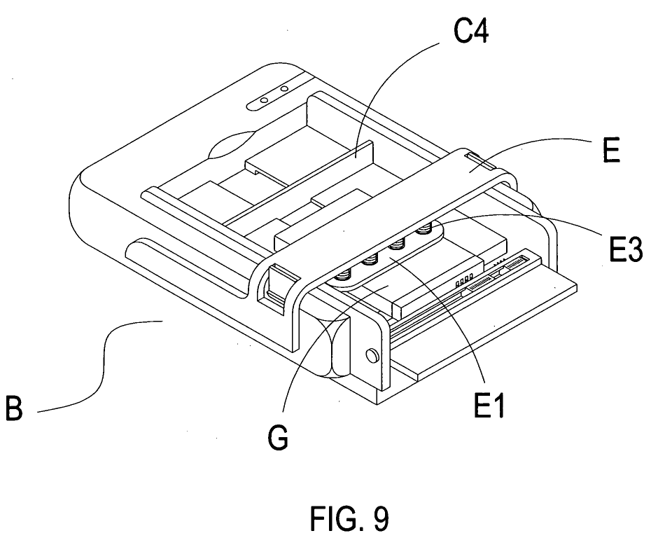

Referring to FIG. 3, FIG. 4, FIG. 5, FIG. 6, FIG. 7, FIG. 8 and FIG. 9, which show an embodiment of the structural assembly of electric exchanger device of the present invention, wherein the connecting pin sets D3, D4 are configured to face the holding space C1 of the electric exchanger device B. The conducting wires D5 extend from the connecting pin sets D3, D4 and are electrically connected to the detector circuit C2 within the main body C (see FIG. 3), thereby enabling effective detection of polarity of a battery F disposed within the holding space C1. Moreover, the moving pieces D2 respectively extend from and are joined to the connecting pin sets D3, D4, and the moving pieces D2 enable the connecting pin sets D3, D4 to be moved within the slide groove D1, thereby enabling moving the connecting pin sets D3, D4 to correspond to connecting pins F1 of the battery F by means of the moving pieces D2. Different spacings between the connecting pins D6 of the connecting pin sets D3, D4 are used to correspond to a battery G having different spacings of pins G1. The stopping strip C3 is disposed on the main body C, and can be moved on the holding space C1 to fixedly clamp position of the battery F. The electric exchanger device B is further configured with the restraining member E, and when the battery F is installed in the holding space C1, downward pressing of the restraining member E is used to enable the clasp pieces E1 to clasp onto the main body C, thereby fixing position of the battery F. Moreover, the fixing piece E2 disposed on the arresting member E is able to increase fixedly securing of position of the battery F, thus enabling the connecting pins F1 of the battery F to secure an electrical connection with the connecting pin set D3, thereby effectively achieving effectiveness to detect polarity of the battery F and exchange electric energy.

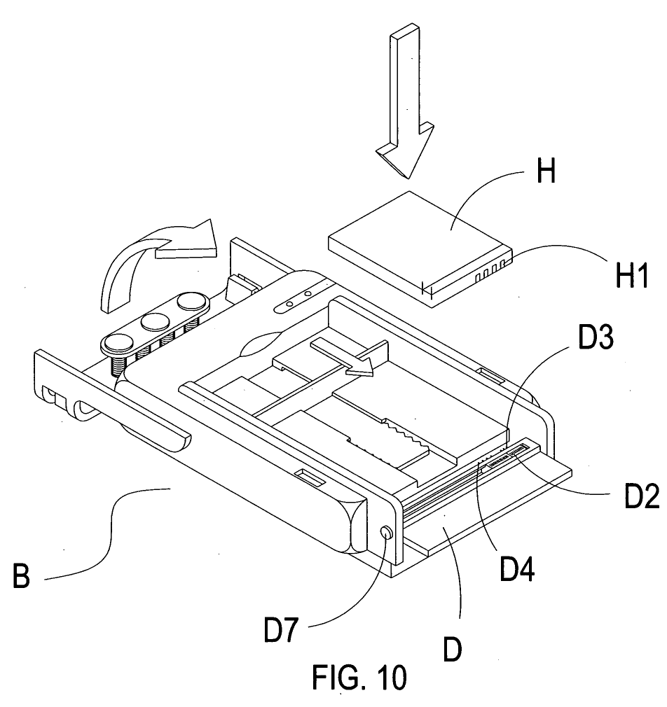

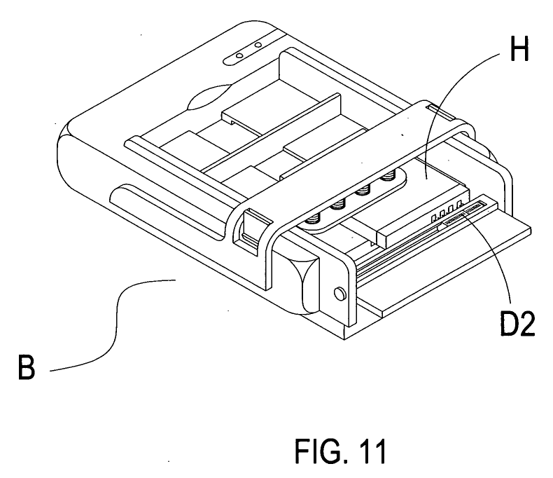

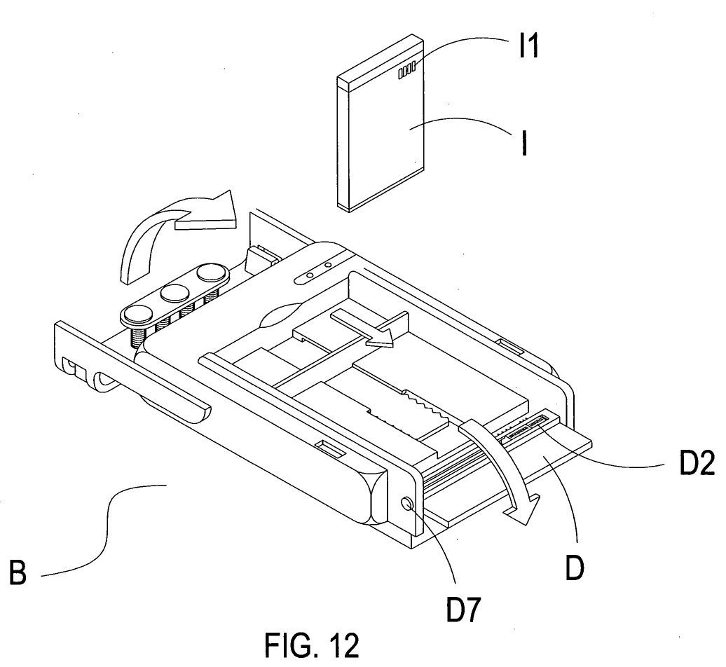

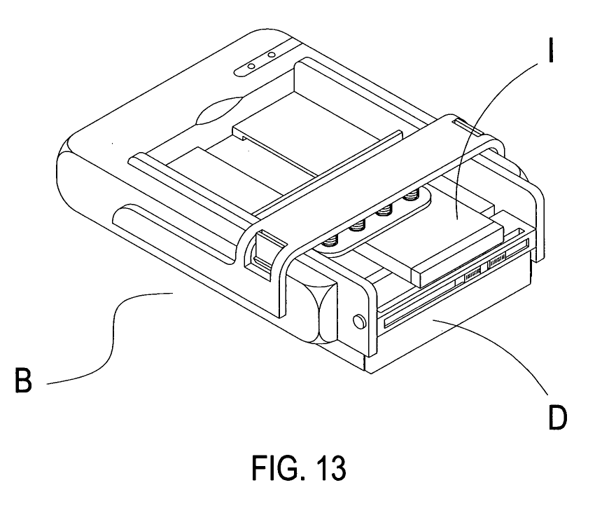

Referring to FIG. 3, FIG. 10, FIG. 11, FIG. 12, and FIG. 13, wherein when wanting to join a battery H having connecting pins H1 with relatively large spacings to the electric exchanger device B, then the moving pieces D2 can be used to push the connecting pin sets D3, D4 to enable the connecting pin set D3 and the connecting pin set D4 to simultaneously join with the pins H1 of the battery H, at which time the detector circuit C2 (see FIG. 3) then uses the connecting pin sets D3, D4 to detect positive and negative poles of the battery H, thereby achieving effectiveness to detect polarity and exchange electric energy. Moreover, the movable member D is installed on the main body C, and the press buttons D7 are respectively located on the two ends of the movable member D. When wanting to join a battery I having different positioned connecting pins I1 to the electric exchanger device B, then pressing the press buttons D7 enables the movable member D to be rotated and fixed, and displacement of the connecting pin sets D3, D4 enables the connecting pin sets D3, D4 to be moved to positions corresponding to the pins I1 of the battery 1, thereby favorably connecting the pins I1 of the battery I to the detector circuit C2 (see FIG. 3), and achieving effectiveness to detect polarity and convert electric energy.

The holding space C1 enables disposal of a lithium battery from a mobile phone, a digital camera, a video camera, a translator, a game machine, a PDA (personal digital assistant), a GPS (Global Positioning System) and any lithium battery used by related electronic devices.

In order to better explicitly disclose advancement and practicability of the present invention, a comparison with prior art is described hereinafter:

Shortcomings of Prior Art

1. Disposition of electric contact pins is fixed, thereby disenabling alteration thereof.

2. Because of shortcoming 1, thus, positive contact pins and negative contact pins of the electric contact pins are fixed.

3. Is only configured to accommodate specifications of a single specific battery.

4. Low compatibility and practicability.

Advantages of the Present Invention

1. The detector circuit C2 is used to automatically detect polarity of a battery.

2. A battery need only be electrically connected to the connecting pins D6 of the connecting pin sets D3, D4 to carry out charging of the battery, and there is no limitation on size of battery or different position and spacings of contact pins of the battery.

3. Able to accommodate different batteries, thereby increasing multivariability and convenience of use.

4. Provided with advancement and practicability.

5. Enhances industrial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A structural assembly of electric exchanger device, comprising a main body, a movable member and a restraining member, an interior of the main body is configured with a detector circuit that enables automatic detection of polarity, and the main body is provided with a holding space able to implement electrical connection, a movable stopping strip that enables fixing a battery is disposed interior of the holding space; the restraining member extends from the main body, and clasp pieces extend from the restraining member, and a fixing piece further extends from the restraining member facing the holding space; wherein the movable member is disposed in the main body, and a slide groove is defined in the movable member, a plurality of moving pieces are embedded in the slide groove, and connecting pin sets are configured on the plurality of moving pieces and electrically connected to the detector circuit using conducting wires; accordingly, a battery disposed within the holding space is electrically connected to the connecting pin sets of the moving pieces, and the connecting pin sets are electrically connected to the detector circuit, thereby enabling detection of polarity of the battery, and disposition of the slide groove and the moving pieces enables the electric exchanger device to accommodate different batteries, thus achieving the objective of electric exchange of the battery.

2. The structural assembly of electric exchanger device according to claim 1, wherein flexible members are located between the fixing piece and the restraining member, thereby enabling the restraining member to accommodate batteries of different thickness.

3. The structural assembly of electric exchanger device according to claim 1, wherein two sets or more than two sets of the connecting pin sets are disposed in the slide groove.

4. The structural assembly of electric exchanger device according to claim 1, wherein each of the connecting pin sets comprises one or more than one connecting pin.

5. The structural assembly of electric exchanger device according to claim 3, wherein spacings between the connecting pins of each of the connecting pin sets are different, thereby enabling the electric exchanger device to effectively accommodate batteries having different pin positions.

6. The structural assembly of electric exchanger device according to claim 1, wherein the holding space enables disposal of a lithium battery from a mobile phone, a digital camera, a video camera, a translator, a game machine, a PDA (personal digital assistant), a GPS (Global Positioning System) and any lithium battery used by related electronic devices.

7. The structural assembly of electric exchanger device according to claim 1, wherein the electric exchanger device has functionality to carry out charging, electric discharging and volumetric analysis.
